(19) United States
(12) Patent Application Publication
(10) Pub. No.: US 2009/0274376 A1
(43) Pub. Date: Nov. 5, 2009

(54) METHOD FOR EFFICIENTLY BUILDING COMPACT MODELS FOR LARGE MULTI-CLASS TEXT CLASSIFICATION

(75) Inventors: Sathiya Keerthi Selvaraj, Cupertino, CA (US); Dmitry Pavlov, San Jose, CA (US); Scott J. Gaffney, Menlo Park, CA (US); Nicolas Eddy Mayoraz, Cupertino, CA (US); Pavel Berkhin, Sunnyvale, CA (US); Vijay Krishnan, Mountain View, CA (US); Sundararajan Sellamanickam, Bangalore (IN)

Correspondence Address: YAHOO! INC.;c/o DUANE MORRIS LLP, Attn.: IP Docketing, 1 Market Plaza - 2000 Spear Tower, San Francisco, CA, 94105-1104, US

(73) Assignee: YAHOO! INC., Sunnyvale, CA (US)

(21) Appl. No.: 12/115,486

(22) Filed: May 5, 2008

(51) Int. Cl. G06K 9/62

(52) U.S. Cl. 382/224

(57) ABSTRACT

A method of classifying documents includes: specifying multiple documents and classes, wherein each document includes a plurality of features and each document corresponds to one of the classes; determining reduced document vectors for the classes from the documents, wherein the reduced document vectors include features that satisfy threshold conditions corresponding to the classes; determining reduced weight vectors for relating the documents to the classes by comparing combinations of the reduced weight vectors and the reduced document vectors and separating the corresponding classes; and saving one or more values for the reduced weight vectors and the classes. Specific embodiments are directed to formulations for determining the reduced weight vectors including one-versus-rest classifiers, maximum entropy classifiers, and direct multiclass Support Vector Machines.

### BACKGROUND OF THE INVENTION

1. Field of Invention

The present invention relates to data analysis generally and more particularly to classifying documents, especially in large multi-class environments.

2. Description of Related Art

Multi-class text classification problems arise in document and query classification problems in many operational settings, either directly as multi-class problems or in the context of developing taxonomies. Many of these tasks are associated with real time applications where fast classification is very important and so there is a necessity to load a small model in main memory during deployment.

Support Vector Machines (SVMs) and Maximum Entropy classifiers are the state of the art methods for multi-class text classification with a large number of features and training examples connected by a sparse data matrix (e.g., each example is a document labeled with a class) [2]. These methods either operate directly on the multi-class problem or in a one-versus-rest mode where for each class a binary classification problem of separating it from the other classes is developed. Suppose a generic example (document) is represented using a large number of bag-of-word or other features, into a vector x sitting in a feature space of dimension n where n is large. The multi-class methods use one weight vector wₘ of dimension n for the m-th class that yields the score for class m as:

sₘ(x)=wₘ^{T}x (1)

where T denotes the vector transpose. The decision function of choosing the winning class is given by the class with the highest score:

argmaxₘwₘ^{T}x. (2)

With one weight vector for each class, there are n×k weight variables in the model, where k is the total number of classes. The number of variables can be prohibitively large when both the number of features and the number of classes are large (e.g., a million features and a thousand classes). In real-time applications loading a model with such a large number of weights during deployment is very hard. The large number of weights also makes the training process slow and challenging to handle in memory (since many vectors having the dimension of the number of weight variables are employed in the training process). They also make the prediction process slow as more computation time is needed to make predictions (that is, to decide the winning class via (2)).

One approach to reducing the number of weight variables is to combine the training process with a method that selects important weight variables and removes the others. An example of such a method is the method of Recursive Feature Elimination (RFE). (See, for example, U.S. Pat. No. 6,789,069, which is incorporated herein by reference in its entirety.) Though effective in many operational settings, these methods can be expensive since, during training, all variables are typically involved.

Thus, there is a need for improved systems and methods for classifying documents.

### SUMMARY OF THE INVENTION

In one embodiment of the present invention, a method of classifying documents includes: specifying multiple documents and classes, wherein each document includes a plurality of features and each document corresponds to one of the classes; determining reduced document vectors for the classes from the documents, wherein the reduced document vectors include features that satisfy threshold conditions corresponding to the classes; determining reduced weight vectors for relating the documents to the classes by comparing combinations of the reduced weight vectors and the reduced document vectors and separating the corresponding classes; and saving one or more values for the reduced weight vectors and the classes.

According to one aspect of this embodiment, saving the one or more values may include saving index values for the features that satisfy the threshold conditions for the classes.

According to another aspect, the classes may correspond to subject matter labels for the documents (e.g., sports, politics, etc.); the features include frequency metrics for textual units in the documents (e.g., a binary indicator function or an averaging function); and specifying the documents includes specifying document vectors for the documents, wherein components of each document vector include the features of a corresponding document.

According to another aspect, determining the reduced document vectors for a given class may include eliminating one or more features from the documents, wherein the one or more features are not present in a threshold number of the documents corresponding to the given class.

According to another aspect, determining the reduced weight vectors may include: determining reduced weight vectors for a given class by calculating corresponding reduced weight vectors to separate the given class from classes other than the given class.

According to another aspect, determining the reduced weight vectors may include: calculating values for the reduced weight vectors to improve an entropy criterion that characterizes a likelihood for using the reduced weight vectors to relate the documents to the classes.

According to another aspect, determining the reduced weight vectors may include: solving a dual problem for the reduced weight vectors by relating the reduced weight vectors to linear combinations of the reduced document vectors and selecting the linear combinations of the reduced document vectors to separate the classes.

According to another aspect, determining the reduced weight vectors may include: solving a sequence of dual subproblems for the reduced weight vectors by relating the reduced weight vectors to linear combinations of the reduced document vectors and selecting the linear combinations of the reduced document vectors to separate the classes, wherein each dual subproblem corresponds to variations related to one of the reduced document vectors.

According to another aspect, determining the reduced weight vectors may include a step for adjusting the reduced weight vectors to improve a criterion for separating the reduced document vectors into their corresponding classes.

According to another aspect, the method may further include: specifying an input document; determining reduced input-document vectors for the classes from the input document; and determining a class for the input document by comparing combinations of the reduced input-document vectors and the corresponding reduced weight vectors.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer. In these ways the present invention enables improved systems and methods for classifying documents

### BRIEF DESCRIPTION OF THE DRAWINGS

FIG. 1 shows an exemplary document classification for embodiments of the present invention.

FIG. 2 shows a method of classifying documents for an embodiment of the present invention.

FIG. 3 shows a support vector machine for an embodiment of the present invention related to FIG. 2.

FIG. 4 shows a shows an exemplary method for determining reduced features and reduced weight vectors for an embodiment of the present invention

FIG. 5 shows an exemplary method for determining reduced weight vectors for an embodiment of the present invention.

FIG. 6 shows another exemplary method for determining reduced weight vectors for an embodiment of the present invention.

FIG. 7 shows another exemplary method for determining reduced weight vectors for an embodiment of the present invention

FIG. 8 shows another exemplary method for determining reduced weight vectors for an embodiment of the present invention

FIG. 9 shows a conventional general purpose computer.

FIG. 10 shows a conventional Internet network configuration.

### DETAILED DESCRIPTION OF EXEMPLARY EMBODIMENTS

Multi-class text classification problems arise in document and query classification problems in a variety of settings including Internet application domains (e.g., for Yahoo!). Consider for example, news stories (text documents) flowing into Yahoo News platform from various sources. There may be a need to classify each incoming document in to one of several pre-defined classes, for example, say one of 4 classes: Politics, Sports, Music and Movies. One could represent a document (call it x) using the words/phrases that occur in that document. Collected over the entire news domain, the total number of features (words/phrases in the vocabulary) can run into a million or more. For instance, the phrase, George Bush may be assigned an id j and x^{j} (the j-th component of the vector x) could be set to 1 if this phrase occurs in the document and 0 otherwise. This is a simple binary representation. However, more general frequency metrics can be used. For example, an alternative method of assigning a value to x^{j}, called the tf-idf method, would be to count the number of occurrences of the phrase George Bush in the document and combine this in various nonlinear ways with how infrequently this phrase occurs over all documents in a news domain. A variety of ways for assigning term weights are well known in this art [4]. Those skilled in the art would find the most appropriate weighting method to set x^{j} for various word/phrase features j depending on the requirements of the operational setting (e.g., accuracy and efficiency for the size of the data sets). Thus, with a suitable choice of weighting, each document is represented as a vector in a large dimensional real feature space.

For training the multi-class classifiers one forms a training set of documents (also called as examples), which is usually formed by an editorial team that looks at a random subset of news documents from the past and assigns a class to each document. We will use xᵢ to denote the vectorial representation of the i-th document. And similarly yᵢ denotes the class that is assigned to this i-th document either by an editorial team or by other means (e.g., Internet voting, computer program, etc.). For the case of four classes, Politics, Sports, Music and Movies mentioned earlier, we can use the integers 1, 2, 3 and 4 to denote the four classes, and so, if the i-th document is about Sports then its yᵢ is set to the value 2, and so on.

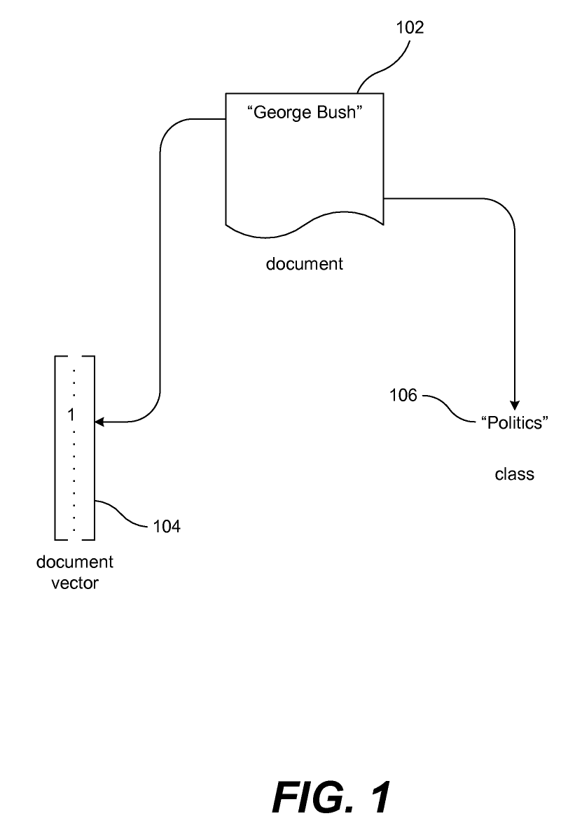

FIG. 1 shows an exemplary document classification for embodiments of the present invention. A document 102 includes multiple words and phrases including the phrase “George Bush.” A document vector 104 has a component with a value that is set to indicate that this document includes this phrase. Additionally, this document has been associated the class “Politics” 106 to indicate the relevant subject matter (e.g., yᵢ=1).

This example illustrates how document representations are formed and how a training set is set-up. In general, in complex scenarios, one can easily think of text classification problems that are large, say, a million features, a million training examples, and a few thousand classes. Moreover, those skilled in the art will realize that although the focus of the disclosed embodiments is directed toward textual features, these embodiments may be applied to more general non-textual features including, for example, colors, shapes and sounds.

In describing the exemplary embodiments the term ‘example’ and ‘document’ will be used interchangeably. In general, a training set is given and it consists of l training examples. One training example consists of a vectorial representation of a document and its corresponding class label. Let n be the number of input features and k be the number of classes. Throughout, the index i will be used to denote a training example and the index m will be used to denote a class. Unless otherwise mentioned, i will run from 1 to l and m will run from 1 to k. Let yᵢε{1, . . . , k} denote the class label of example i. In the traditional multi-class model using the full feature representation, xᵢεRⁿ is the input vector associated with the i-th example. In our reduced feature representation, xᵢ^{m} will denote the reduced representation of xᵢ for class m. For a generic vector x outside the training set we will simply omit the subscript i and x^{m} will denote the reduced representation of x for class m. We will use superscript R to distinguish an item associated with reduced feature representation.

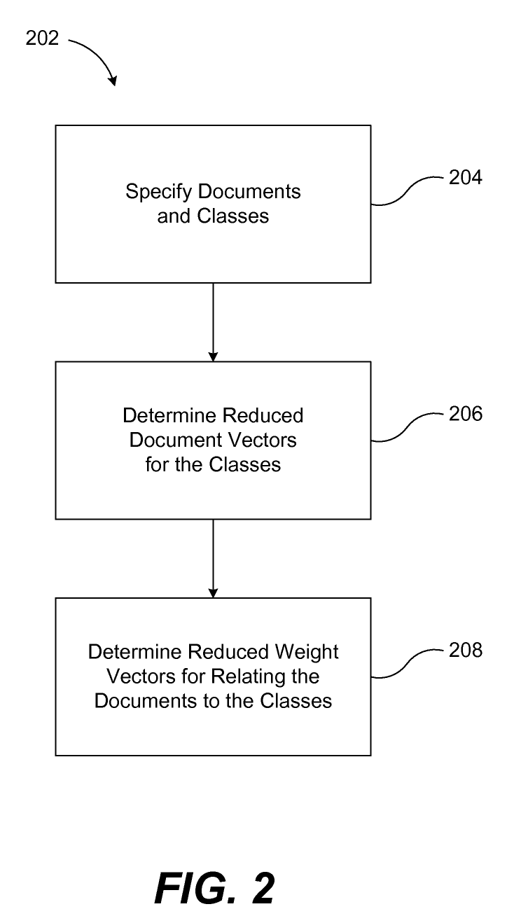

An embodiment of the present invention is shown in FIG. 2. A method 202 of classifying documents includes specifying documents and classes 204, determining reduced document vectors for the classes from the documents 206, and determining reduced weight vectors for relating the documents to the classes by comparing combinations of the reduced weight vectors and the reduced document vectors and separating the corresponding classes 208. Each document includes multiple features and each document corresponds to one of the classes. As described below in greater detail, the reduced document vectors include features that satisfy threshold conditions corresponding to the classes.

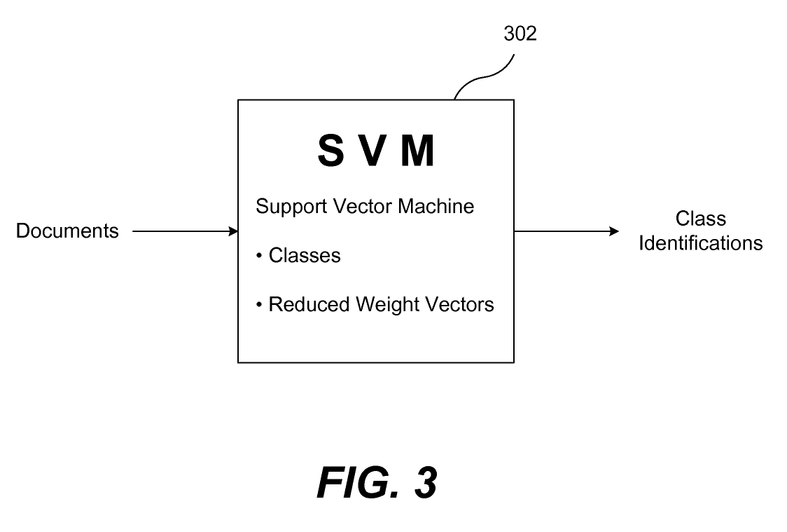

One or more values for the reduced weight vectors and the classes can be saved for future document classifications. For example, the saved values may include index values for the features that satisfy the threshold conditions for the classes. FIG. 3 shows a Support Vector Machine (SVM) 302 that is defined by the results of the method so that input documents can be classified using the reduced weight vectors.

In this embodiment determining the reduced document vectors 206 for a given class includes eliminating one or more features from the documents where these features are not present in a threshold number of the documents corresponding to the given class. To be more precise, given a training set of labeled documents, for the m-th class we do not use the full x, but rather a subset vector x^{m} which consists of only the feature elements of x for which there is at least lₜₕ^{m} training examples xᵢ with label m with a non-zero value for that feature element. lₜₕ^{m} is a threshold size that can be set to a small number, say an integer between 1 and 5. The setting of a value could depend on the application under consideration. Under lack of such knowledge, one can simply set lₜₕ^{m} to a default value, say 3. Essentially we are saying that a feature has to occur in at least 3 training documents of a given class for it to be considered for inclusion. As a special case, we can set the same threshold for all the classes. Let n^{m} denote the number of such chosen features for class m, i.e., the dimension of x^{m}. Let us use wₘ^{R} to denote the reduced weight vector for class m, leading to the modified scoring function,

sₘ^{R}(x^{m})=(wₘ^{R})^{T}x^{m}. (3)

Thus the total number of weight variables in such a reduced model is N^{R}=Σₘn^{m} as opposed to N=n×k in the full model. Typically N^{R} is much smaller than N. In the case of a million features and a thousand classes, if there are roughly 10⁴ non-zero features for each class, then N=10⁹ versus N^{R}=10⁷, which is two orders of magnitude reduction in the total number of weights. In this way, substantial efficiencies can be achieved by choosing a sparse weight vector for each class, with non-zero weights permitted only for features that appear at least a certain minimum number of times in the given class. Intuitively these retained features encode the most information, and the other features are somewhat redundant in forming the scoring function for that class. With reference to FIG. 1, for example, the document vector 104 is associated with a reduced document vector for each class, where this reduced document vector typically has a much smaller dimension depending which features are more relevant for a given class. In this case, the feature corresponding to the incidence of the phrase George Bush is typically more likely to be retained in a reduced document vector for the Politics class as compared with classes for Sports, Music and Movies.

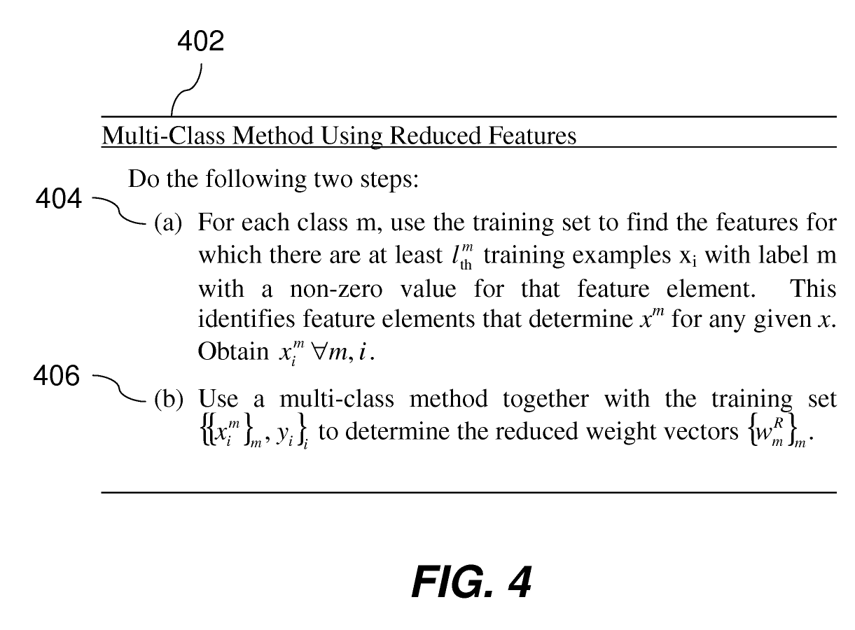

FIG. 4 shows an exemplary method 402 for determining reduced features and reduced weight vectors according to an embodiment of the present invention. This method 402 provides more specific details applicable to the more general method 202 shown in FIG. 2. For each class m, reduced features are identified 404 by comparing the number of training examples (or documents) where that feature is found a threshold number of times with a non-zero value. (Alternatively, other comparisons for a frequency metric could be used rather than a non-zero value indicating mere presence of a feature in an example or document.) Next a multi-class method is used together with the training set to determine the reduced weight vectors 406.

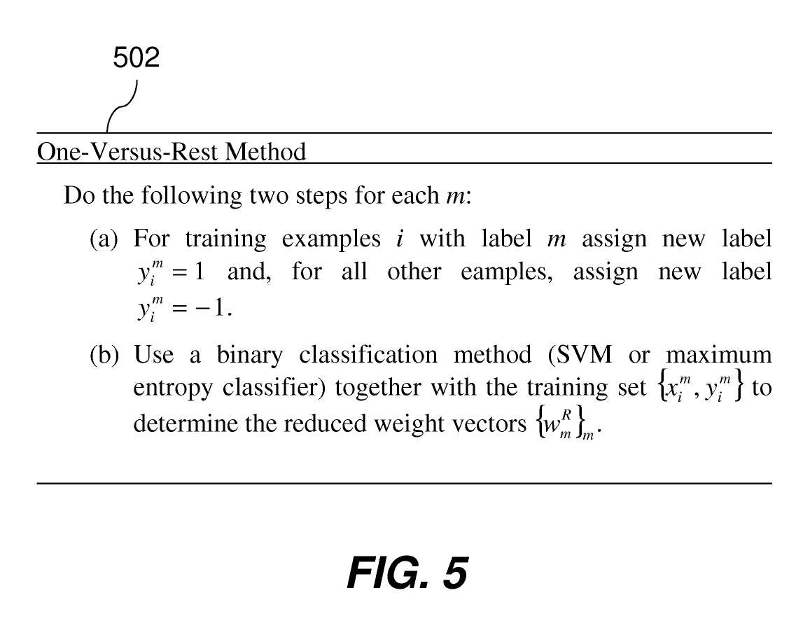

As described below in greater detail with reference to FIGS. 5-8, the reduced weight vectors can be determined 406 in a variety of ways.

FIG. 5 shows an exemplary method 502 for determining the reduced weight vectors in a one-versus-rest framework. That is, one can take one class at a time (e.g., class m) and design wₘ^{R} to solve the binary classification problem of separating training examples belonging to class m from the others. For example, a support vector machine (SVM) or maximum entropy classifier can be used to solve the binary classification problem.

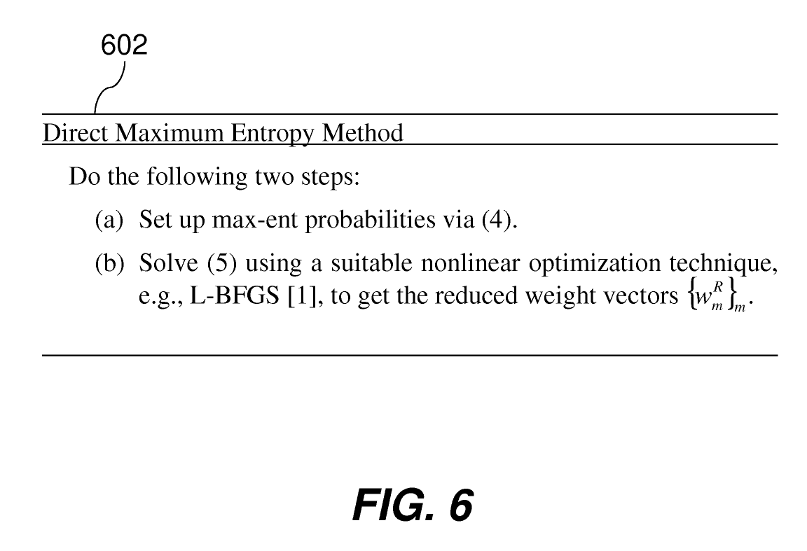

FIG. 6 shows an exemplary method 602 for determining the reduced weight vectors using a maximum entropy principle. In this context, the entropy criterion characterizes a likelihood for using the reduced weight vectors to relate the documents to the classes. To do this, we define the class probability for class m as

$${p}_{i}^{m} = \frac{exp ( {s}_{m}^{R} ( {x}_{i}^{m} ) )}{{\sum }_{y = 1}^{k} exp ( {s}_{y}^{R} ( {x}_{i}^{y} ) )} . \qquad ( 4 )$$

Joint training of all weights, {wₘ^{R}}ₘ₌₁^{k} is done by solving the optimization problem

$$min \frac{1}{2} {\sum }_{m} {‖ {w}_{m}^{R} ‖}^{2} - C {\sum }_{m} log {p}_{i}^{m} \qquad ( 5 )$$

where C is a regularization constant that is either fixed at some chosen value, say C=1 or may be chosen by cross validation. The method 602 includes using eq. (4) to characterize probabilities induced by the reduced weights and optimizing the corresponding regularized likelihood given by eq. (5) (e.g., by means of conventional techniques such as L-BFGS [1]).

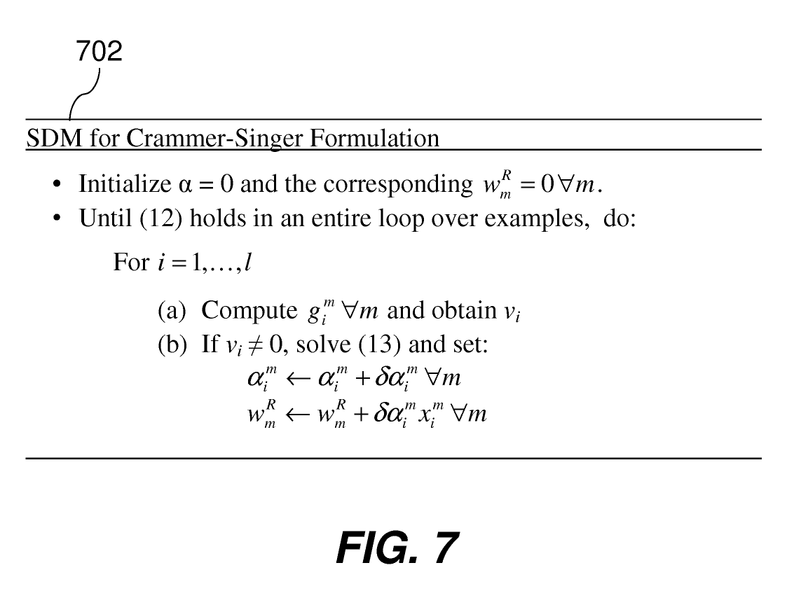

FIG. 7 shows an exemplary method 702 for determining the reduced weight vectors by using a Sequential Dual Method (SDM) for a Crammer-Singer formulation [2]. In this formulation, the reduced feature representation is modified by solving the following primal problem:

$$min \frac{1}{2} {\sum }_{m} {‖ {w}_{m}^{R} ‖}^{2} + C {\sum }_{i} {ξ}_{i} \\ s . t . {( {w}_{{y}_{i}}^{R} )}^{T} {x}_{i}^{{y}_{i}} - {( {w}_{m}^{R} )}^{T} {x}_{i}^{m} \geq {e}_{i}^{m} - {ξ}_{i} ∀ m , i , \qquad ( 6 )$$

where C is a regularization constant, eᵢ^{m}=1−δ_{y}_{ᵢ}_{,m} and δ_{y}_{ᵢ}_{,m} if yᵢ=m, and δ_{y}_{ᵢ}_{,m}=0 if yᵢ≠m. Note that, in (6) the constraint for m=yᵢ corresponds to the non-negativity constraint, ξᵢ≧0.

The dual problem of (6) involves a vector α having dual variables αᵢ^{m} ∀m,i. Let us define

$${w}_{m}^{R} ( α ) = {\sum }_{i} {α}_{i}^{m} {x}_{i}^{m} \qquad ( 7 )$$

and Cᵢ^{m}=0 if yᵢ≠m, Cᵢ^{m}=C if yᵢ=m. The dual problem is

$${min}_{α} f ( α ) = \frac{1}{2} {\sum }_{m} {‖ {w}_{m}^{R} ( α ) ‖}^{2} + {\sum }_{i} {\sum }_{m} {e}_{i}^{m} {α}_{i}^{m} \\ s . t . ( {α}_{i}^{m} \leq {C}_{i}^{m} ∀ m , {\sum }_{m} {α}_{i}^{m} = 0 ) ∀ i . \qquad ( 8 )$$

The derivative of f is given by

$${g}_{i}^{m} = \frac{\partial f ( α )}{\partial {α}_{i}^{m}} = {{w}_{m}^{R} ( α )}^{T} {x}_{i}^{m} + {e}_{i}^{m} . \qquad ( 9 )$$

Optimality of α for (8) can be checked using the quantity,

$${v}_{i} = {max}_{m} {g}_{i}^{m} - {min}_{m : {α}_{i}^{m} < {C}_{i}^{m}} {g}_{i}^{m} . \qquad ( 10 )$$

From (10) it is clear that vᵢ is non-negative. Optimality holds when:

vᵢ=0∀i. (11)

For practical termination of a dual algorithm we can approximately check this using a tolerance parameter, ε>0:

vᵢ<ε∀i. (12)

An ε value of 0.1 is generally found to give good solutions.

The Sequential Dual Method (SDM) consists of sequentially picking one i at a time and solving the restricted problem of optimizing only αᵢ^{m}∀m. To do this, we let δαᵢ^{m} denote the change to be applied to the current aᵢ^{m}, and optimize δαᵢ^{m}∀m. With Aᵢ^{m}=∥xᵢ^{m}∥² the sub-problem of optimizing the δαᵢ^{m} is given by

$$min \frac{1}{2} {\sum }_{m} {{A}_{i}^{m} ( {δα}_{i}^{m} )}^{2} + {\sum }_{m} {g}_{i}^{m} {δα}_{i}^{m} \\ s . t . {δα}_{i}^{m} \leq {C}_{i}^{m} - {α}_{i}^{m} ∀ m , {\sum }_{m} {δα}_{i}^{m} = 0. \qquad ( 13 )$$

The details of the method 702 are summarized in FIG. 7. The following three heuristics may be used to speed up the algorithm. First, in each loop, instead of presenting the examples i=1, . . . , l in the given order, one can randomly permute them and then do the updates for one loop over the examples. Secondly, after a loop through all the examples, we may only update an αᵢ^{m} if it is non-bounded (i.e., it is not at Cᵢ^{m}), and, after a few rounds of such ‘shrunk’ loops (which may be terminated earlier if ε optimality is satisfied on all αᵢ^{m} variables under consideration), return to the full loop of updating all αᵢ^{m}. Third, we can use a cooling strategy for changing ε, i.e., start with ε=1, solve the problem and then re-solve using ε=0.1.

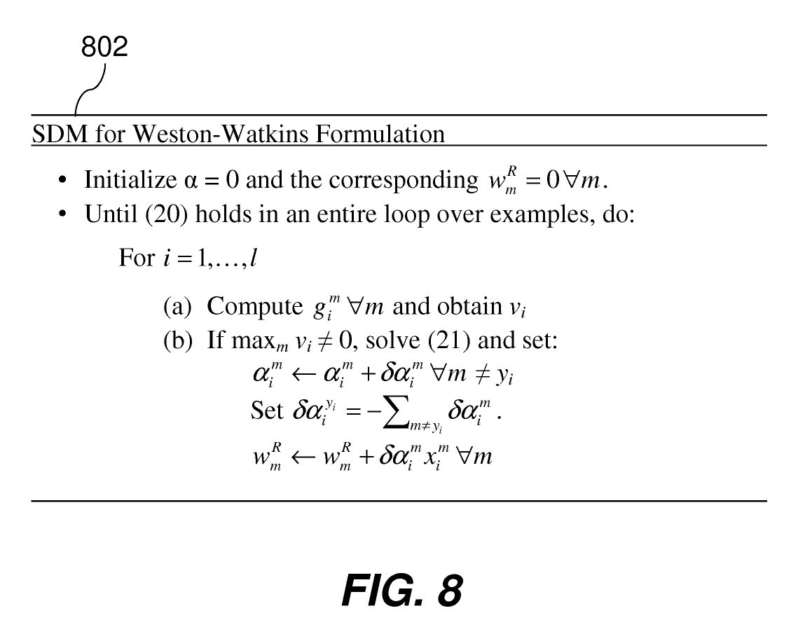

FIG. 8 shows an exemplary method for determining the reduced weight vectors by using a Sequential Dual Method (SDM) for a Weston-Watkins formulation [5]. In this formulation, the reduced feature representation is modified by solving the following primal problem:

$$min \frac{1}{2} {\sum }_{m} {‖ {w}_{m}^{R} ‖}^{2} + C {\sum }_{i} {\sum }_{m \neq {y}_{i}} {ξ}_{i}^{m} \\ s . t . {( {w}_{{y}_{i}}^{R} )}^{T} {x}_{i}^{{y}_{i}} - {( {w}_{m}^{R} )}^{T} {x}_{i}^{m} \geq {e}_{i}^{m} - {ξ}_{i}^{m} , {ξ}_{i}^{m} \geq 0 ∀ m \neq {y}_{i} , i . \qquad ( 14 )$$

The dual problem of (14) involves a vector α having dual variables αᵢ^{m}∀i, m≠yᵢ. For convenience let us set

$${α}_{i}^{{y}_{i}} = - {\sum }_{m \neq {y}_{i}} {α}_{i}^{m} , \\ and define \\ {w}_{m}^{R} ( α ) = - {\sum }_{i} {α}_{i}^{m} {x}_{i}^{m} . \qquad ( 15 )$$

The dual of (14) can now be written as

$${min}_{α} f ( α ) = \frac{1}{2} {\sum }_{m} {‖ {w}_{m}^{R} ( α ) ‖}^{2} + {\sum }_{i = 1} {\sum }_{m \neq {y}_{i}} {α}_{i}^{m} \\ s . t . 0 \leq {α}_{i}^{m} \leq C ∀ m \neq {y}_{i} , ∀ i . \qquad ( 16 )$$

For m≠yᵢ the derivative of f is given by

$${g}_{i}^{m} = \frac{\partial f ( α )}{\partial {α}_{i}^{m}} = {{w}_{{y}_{i}}^{R} ( α )}^{T} {x}_{i}^{{y}_{i}} - {{w}_{m}^{R} ( α )}^{T} {x}_{i}^{m} - 1. \qquad ( 17 )$$

Optimality can be checked using the quantity:

$${v}_{i}^{m} = \{ \begin{matrix}{g}_{i}^{m} & if 0 < {α}_{i}^{m} < C , \\ max ( 0 , - {g}_{i}^{m} ) & if {α}_{i}^{m} = 0 , \\ max ( 0 , {g}_{i}^{m} ) & if {α}_{i}^{m} = C .\end{matrix} \qquad ( 18 )$$

Optimality holds when:

vᵢ^{m}=0∀m≠i,∀i. (19)

For practical termination we can approximately check this using a tolerance parameter ε>0:

vᵢ^{m}<ε∀m≠i,∀i. (20)

An ε value of 0.1 is generally found to give good solutions. With Aᵢ^{m}=∥xᵢ^{m}∥² the sub-problem of optimizing the δαᵢ^{m} is given by

$$min \frac{1}{2} {\sum }_{m \neq {y}_{i}} {{A}_{i}^{m} ( {δα}_{i}^{m} )}^{2} + \frac{1}{2} {{A}_{i}^{{y}_{i}} ( {\sum }_{m \neq {y}_{i}} ( {δα}_{i}^{m} ) )}^{2} + {\sum }_{m \neq y} {g}_{i}^{m} {δα}_{i}^{m} \\ s . t . 0 \leq {δα}_{i}^{m} \leq {C}_{i}^{m} - {α}_{i}^{m} ∀ m \neq {y}_{i} . \qquad ( 21 )$$

The details of the method 802 are summarized in FIG. 8. The three heuristics described above with respect to the method 702 based on the Crammer-Singer formulation are also applicable for this method 802.

The choice between the above described methods for determining the reduced weight vectors may vary according to the requirements of the operational setting (e.g., accuracy and efficiency requirements for the size of the data sets). The method 502 based on a one-versus-rest framework is an indirect approach to multi-class solution and so may give slightly inferior performance. Because of its relatively simple structure, this method 502 may be desirable in some contexts, but, in general, this method 502 should be preferred only when there is no access to software that do one of the other three direct multi-class solutions. When the number of examples in the training set is not too big, say, less than a hundred thousand, then the method 602 based on the direct maximum entropy solution is reasonably fast. However, on much larger training sets (e.g., a million examples) the Crammer-Singer method and the Weston-Watkins dual SVM methods 702, 802 are generally very much faster and should be preferred. In some cases with large data sets, the Crammer-Singer method 702 appears to be preferable to the Weston-Watkins method 802 and results in better solutions for separating the classes.

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., monitor, keyboard, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet.

At least some values based on the results of the method can be saved, either in memory (e.g., RAM (Random Access Memory)) or permanent storage (e.g., a hard-disk system) for later use. For example, values for the reduced weight vectors and the classes can be saved directly for applications in document classification (e.g., a Support Vector Machine 302). Alternatively, some derivative or summary form of the results (e.g., averages, interpolations, etc.) can be saved for later use according to the requirements of the operational setting.

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

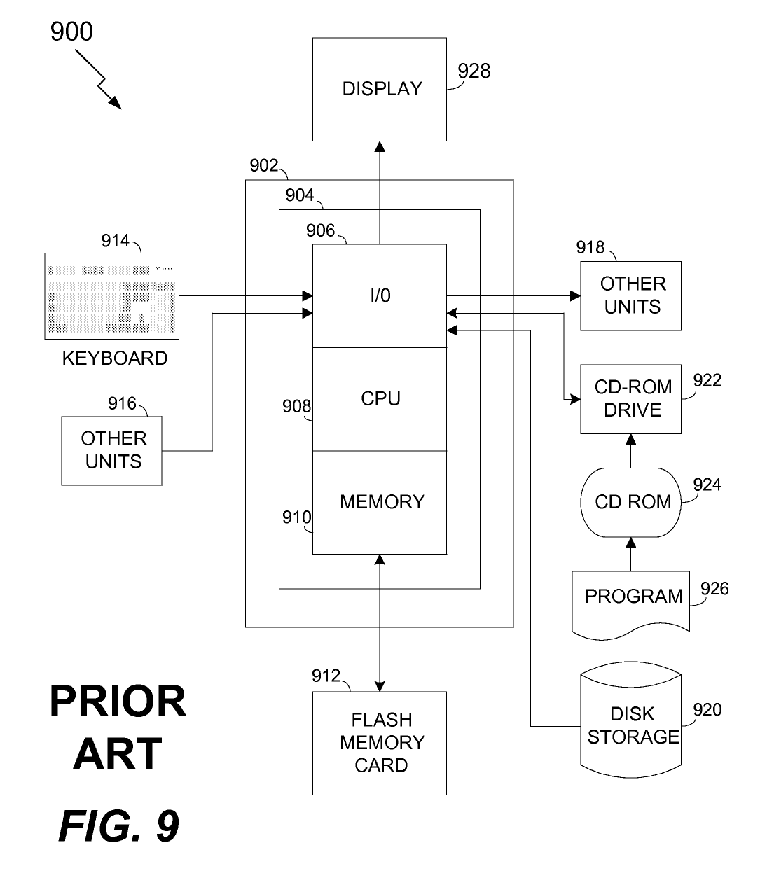

As described above, certain embodiments of the present invention can be implemented using standard computers and networks including the Internet. FIG. 9 shows a conventional general purpose computer 900 with a number of standard components. The main system 902 includes a motherboard 904 having an input/output (I/O) section 906, one or more central processing units (CPU) 908, and a memory section 910, which may have a flash memory card 912 related to it. The I/O section 906 is connected to a display 928, a keyboard 914, other similar general-purpose computer units 916, 918, a disk storage unit 920 and a CD-ROM drive unit 922. The CD-ROM drive unit 922 can read a CD-ROM medium 934 which typically contains programs 926 and other data. Logic circuits or other components of these programmed computers will perform series of specifically identified operations associated with customers, merchants, and value-account systems.

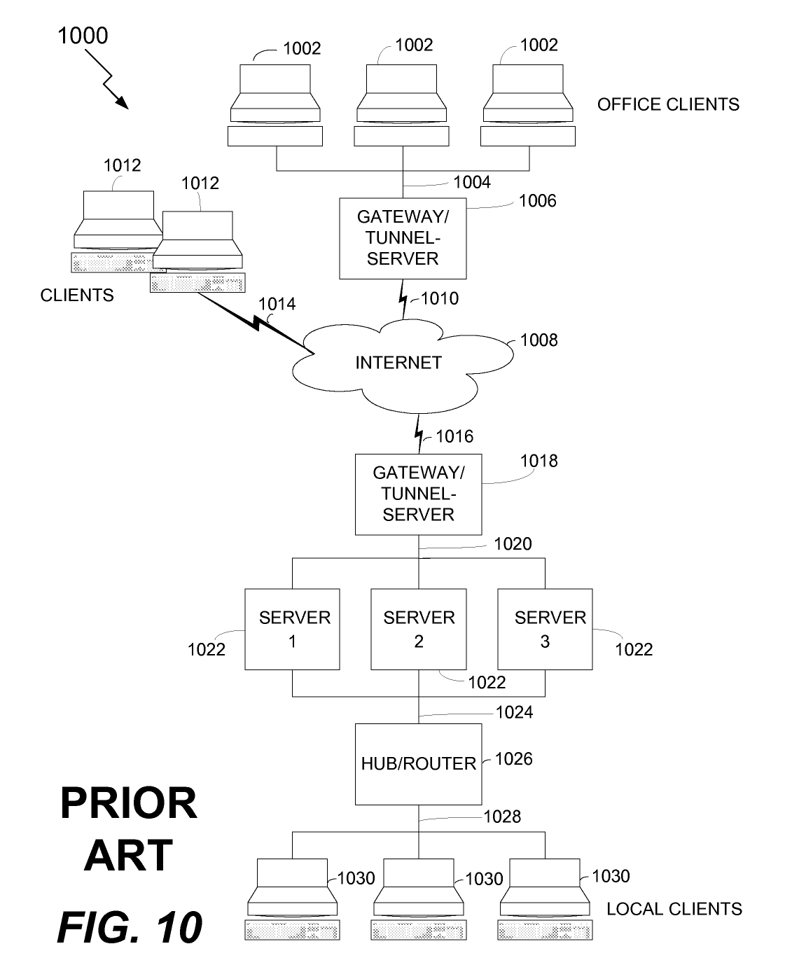

FIG. 10 shows a conventional Internet network configuration 1000, where a number of office client machines 1002, possibly in a branch office of an enterprise, are shown connected 1004 to a gateway/tunnel-server 1006 which is itself connected to the Internet 1008 via some internet service provider (ISP) connection 1010. Also shown are other possible clients 1012 similarly connected to the internet 1008 via an ISP connection 1014. An additional client configuration is shown for local clients 1030 (e.g., in a home office). An ISP connection 1016 connects the Internet 1008 to a gateway/tunnel-server 1018 that is connected 1020 to various enterprise application servers 1022. These servers 1022 are connected 1024 to a hub/router 1026 that is connected 1028 to various local clients 1030.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

The following references are related to the disclosed subject matter:
[1] R. H. Byrd, P. Lu, J. Nocedal, and C. Zhu. A limited memory algorithm for bound constrained optimization. SIAM J. Sci. Statist. Comput., 16:1190-1208, 1995.
[2] A. Berger, S. Della Pietra, and V. Della Pietra. A maximum entropy approach to natural language processing. Computational Linguistics, 22(1), pp. 39-71, 1996.
[3] K. Crammer and Y. Singer. On the learnability and design of output codes for multiclass problems. Computational Learning Theory, pages 35-46, 2000.
[4] F. Sebastiani. Machine learning in automated text categorization. ACM Computing Surveys, 34:1-47, 2002.
[5] J. Weston and C. Watkins. Multi-class support vector machines. In M. Verleysen, editor, Proceedings of ESANN99, Brussels, 1999. D. Facto Press.

What is claimed is:

1. A method of classifying documents, comprising:
specifying a plurality of documents and classes, wherein each document includes a plurality of features and each document corresponds to one of the classes;
determining reduced document vectors for the classes from the documents, wherein the reduced document vectors include features that satisfy threshold conditions corresponding to the classes;
determining reduced weight vectors for relating the documents to the classes by comparing combinations of the reduced weight vectors and the reduced document vectors and separating the corresponding classes; and
saving one or more values for the reduced weight vectors and the classes.

2. A method according to claim 1, wherein saving the one or more values includes saving index values for the features that satisfy the threshold conditions for the classes.

3. A method according to claim 1, wherein
the classes correspond to subject matter labels for the documents;
the features include frequency metrics for textual units in the documents; and
specifying the documents includes specifying document vectors for the documents, wherein components of each document vector include the features of a corresponding document.

4. A method according to claim 1, wherein determining the reduced document vectors for a given class includes: eliminating one or more features from the documents, wherein the one or more features are not present in a threshold number of the documents corresponding to the given class.

5. A method according to claim 1, wherein determining the reduced weight vectors includes: determining reduced weight vectors for a given class by calculating corresponding reduced weight vectors to separate the given class from classes other than the given class.

6. A method according to claim 1, wherein determining the reduced weight vectors includes: calculating values for the reduced weight vectors to improve an entropy criterion that characterizes a likelihood for using the reduced weight vectors to relate the documents to the classes.

7. A method according to claim 1, wherein determining the reduced weight vectors includes: solving a dual problem for the reduced weight vectors by relating the reduced weight vectors to linear combinations of the reduced document vectors and selecting the linear combinations of the reduced document vectors to separate the classes.

8. A method according to claim 1, wherein determining the reduced weight vectors includes: solving a sequence of dual subproblems for the reduced weight vectors by relating the reduced weight vectors to linear combinations of the reduced document vectors and selecting the linear combinations of the reduced document vectors to separate the classes, wherein each dual subproblem corresponds to variations related to one of the reduced document vectors

9. A method according to claim 1, wherein determining the reduced weight vectors includes a step for adjusting the reduced weight vectors to improve a criterion for separating the reduced document vectors into their corresponding classes.

10. A method according to claim 1, further comprising:
specifying an input document;
determining reduced input-document vectors for the classes from the input document; and
determining a class for the input document by comparing combinations of the reduced input-document vectors and the corresponding reduced weight vectors.

11. An apparatus for classifying documents, the apparatus comprising a computer for executing computer instructions, wherein the computer includes computer instructions for:
specifying a plurality of documents and classes, wherein each document includes a plurality of features and each document corresponds to one of the classes;
determining reduced document vectors for the classes from the documents, wherein the reduced document vectors include features that satisfy threshold conditions corresponding to the classes;
determining reduced weight vectors for relating the documents to the classes by comparing combinations of the reduced weight vectors and the reduced document vectors and separating the corresponding classes; and
saving one or more values for the reduced weight vectors and the classes.

12. An apparatus according to claim 11, wherein determining the reduced document vectors for a given class includes: eliminating one or more features from the documents, wherein the one or more features are not present in a threshold number of the documents corresponding to the given class.

13. An apparatus according to claim 11, further comprising means for adjusting the reduced weight vectors to improve a criterion for separating the reduced document vectors into their corresponding classes.

14. An apparatus according to claim 11, wherein the computer further includes computer instructions for:
specifying an input document;
determining reduced input-document vectors for the classes from the input document; and
determining a class for the input document by comparing combinations of the reduced input-document vectors and the corresponding reduced weight vectors.

15. An apparatus according to claim 11, wherein the computer includes a processor with memory for executing at least some of the computer instructions.

16. An apparatus according to claim 11, wherein the computer includes circuitry for executing at least some of the computer instructions.

17. A computer-readable medium that stores a computer program for classifying documents, wherein the computer program includes instructions for:
specifying a plurality of documents and classes, wherein each document includes a plurality of features and each document corresponds to one of the classes;
determining reduced document vectors for the classes from the documents, wherein the reduced document vectors include features that satisfy threshold conditions corresponding to the classes;
determining reduced weight vectors for relating the documents to the classes by comparing combinations of the reduced weight vectors and the reduced document vectors and separating the corresponding classes; and
saving one or more values for the reduced weight vectors and the classes.

18. A computer-readable medium according to claim 17, wherein determining the reduced document vectors for a given class includes: eliminating one or more features from the documents, wherein the one or more features are not present in a threshold number of the documents corresponding to the given class.

19. A computer-readable medium according to claim 17, wherein determining the reduced weight vectors includes a step for adjusting the reduced weight vectors to improve a criterion for separating the reduced document vectors into their corresponding classes.

20. A computer-readable medium according to claim 17, wherein the computer program further includes instructions for:
specifying an input document;
determining reduced input-document vectors for the classes from the input document; and
determining a class for the input document by comparing combinations of the reduced input-document vectors and the corresponding reduced weight vectors.
